(19) United States
(12) Patent Application Publication
(10) Pub. No.: US 2006/0039149 A1
(43) Pub. Date: Feb. 23, 2006

(54) Decorative lens illuminated by LEDs

(76) Inventors: Mohammad Ali Jamnia, Chicago, IL (US); Jack Chen, Oak Brook, IL (US); Patrick Forster, Westmont, IL (US); Kenneth G. Such, North Barrington, IL (US)

Correspondence Address: ROBERT L. MARSH, 54 DANADA DRIVE, P.O. BOX 4468, WHEATON, IL, 60187-4468, US

(21) Appl. No.: 10/921,017

(22) Filed: Aug. 18, 2004

(51) Int. Cl. F21S 6/00

(52) U.S. Cl. 362/257

(57) ABSTRACT

An illuminated lens is provided to illuminate the interior of a vending machine so that prospective patrons of the machine can see the products being offered for sale. Around the outer ends of the transparent lens is a frame made of aluminum, and deposited along the inner surface of the aluminum frame are deposits for forming a plurality of spaced LEDs. The light from the LEDs is directed into the outer end of the lens to thereby illuminate objects behind the lens.

The present invention relates to illuminated lenses of the type incorporated in vending machines and the like, for illuminating advertising material or illuminating the products offered for sale in the machine, and in particular to an improved lens illuminated by LEDs.

### BACKGROUND OF THE INVENTION

To promote the products being sold in a vending machine, the vending machine may provide for a transparent front panel or lens, through which the products being offered for sale are visible. To highlight the products being offered for sale, it is common to provide lighting within the enclosure of the machine. Currently, fluorescent lighting systems are used to illuminate the interiors of a vending machine, however, there are certain limitations to the use of fluorescent lighting. Specifically, fluorescent lighting has a relatively short useable life and fluorescent lighting has difficulty in starting and maintaining the rated light capacity in cold weather.

It would be desirable to provide lighting to the interior of a vending machine using LEDs because LEDs have a relatively long life expectancy and are less subject to failure as a result of environmental conditions. On the other hand, currently available LEDs provide significantly less light per unit than is available from fluorescent lighting, and therefore a large number of LEDs would be needed to provide the desired lighting which would require a correspondingly more complex and costly wiring network. It would therefore be desirable to provide a lens illuminated by LEDs for which the necessary wiring could be inexpensively provided. It would also be desirable to provide an illuminated lens that could offer features such as dancing lights in which the colors and the patterns provided by the lighting could change over time.

### SUMMARY OF THE INVENTION

Briefly, the present invention relates to an illuminating lens for illuminating and highlighting the products being sold in a vending machine or illuminating advertising material on the surface of a vending machine. The lens is made of a transparent material such as a transparent plastic or acrylic and has a forward surface, a rearward surface, and an outer end that extends around the perimeter thereof. The lens is retained in a frame, which is preferably made of a material that is both heat conductive and electrically conductive, such as cast aluminum. The lens is retained against an inner surface of the frame where the inner surface has dielectric material deposited thereon to form a plurality of spaced LEDs. The electrically conductive qualities of the frame therefore provide one of the contacts for the LEDs. A second contact for the LEDs is provided by one or more buses that extend around the perimeter of the frame and is insulated there from by an insulating material. It should be appreciated that the material separating the one or more buses from the metal from which the frame is made may be partially conductive of electricity, where the conductive qualities of the material are considerably less than the conductive qualities of the bus and the metal of the frame.

In accordance with the invention, a plurality of the LEDs is formed in the inner surface of the frame, where the light emitted from the LEDs is projected into the outer ends of the lens. It may be desirable to provide a profile at the outer ends of the lens, such that the qualities of the light emitted from the LEDs are enhanced. It may also be desirable to provide LEDs that produce a plurality of colors with each color or combination of colors having one contact connected to only one of the plurality of buses extending around the frame. By providing a plurality of buses with each of the buses illuminating a different combination of LEDs, the buses may be sequentially energized according to a program so as to create a changing pattern of colors of light that is projected into the lens, forming a “dancing lights” effect.

The LEDs embedded in the frame will produce heat, and the invention further requires a suitable method of dissipating heat. In accordance with the invention, the frame is made of a heat conductive material such as aluminum and serves as a heat sink for the LEDs formed on the surface thereof. The outer perimeter of the frame is adapted to disburse heat, and may be configured as one or more fins around which the surrounding air can circulated. Alternately, the frame may have one or more channels around the outer perimeter thereof through which air can be conducted for cooling the LEDs.

In one embodiment of the invention, the illuminated lens is used to illuminate the interior of a vending machine so that a patron can see the products being offered for sale through the lens. In a second embodiment of the invention, the lens is used to illuminate graphics material on a generally planar surface, such as the forward surface of a vending machine. Positioned behind the panel of graphics material is a reflective surface to reflect forwardly a light passing through the graphics panel.

In another embodiment of the invention, a touch grid may be provided behind the graphics panel and behind the reflective panel. The touch grid will permit a customer to select a desired product by touching the outer surface of the lens in the proximity of where the product is depicted. In yet another embodiment of the invention, a proximity sensor could be provided to detect the approach of a potential customer and change the pattern of lighting directed to the LEDs in response to the approach of the customer.

### BRIEF DESCRIPTION OF THE DRAWINGS

A better understanding of the invention will be had after a reading of the following detailed description taken in conjunction with the drawings wherein:

FIG. 1 is an isometric view of a vending machine having an illuminated lens in accordance with the invention to illuminate the products being offered for sale therein;

FIG. 2 is an enlarged front elevational view of an illuminated viewing lens in accordance with the invention and as shown in FIG. 1;

FIG. 3 is a fragmentary, further enlarged cross-sectional view of the lens and surround frame shown in FIG. 2 taken through lines 3-3 thereof;

FIG. 3A is an exploded cross-sectional view of an end of the lens and the portion of the frame shown in FIG. 3;

FIG. 4 is a fragmentary cross-sectional view showing the end surface of the frame member shown in FIG. 3 taken through line 4-4 thereof;

FIG. 5 is a cross-sectional view of a second embodiment of a frame member; and

FIG. 6 is an exploded view of the components of a frame and lens in accordance with another embodiment of the invention.

### DETAILED DESCRIPTION OF PREFERRED EMBODIMENT

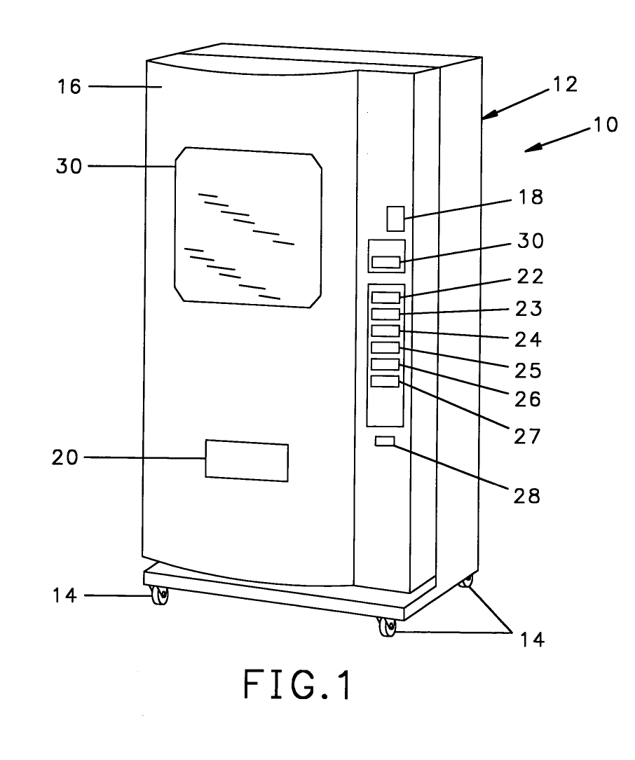

Referring to FIG. 1, a vending machine 10 includes a generally box-shaped enclosure 12 moveable on a plurality of casters 14. Positioned on the forward panel 16 of the enclosure 12 is a coin receptor 18, or any other device for receiving payment for the goods to be dispensed by the machine, an access opening 20 through which the purchased goods can be retrieved by a customer, and a plurality of selector buttons 22-27, any one of which may be depressed by a patron who has deposited the necessary funds into the coin receptor 18. Below the selector buttons 22-27 is a refund slot 28 into which excess funds deposited by the purchaser can be returned, or in the event that the selected magazine is empty, all funds deposited may be returned. Centrally located in the forward panel 16 of the machine is a transparent panel or lens 30 that allows a potential patron of the machine to see into the interior of the machine and view products being offered for sale as they hang on dispensing augers or the like.

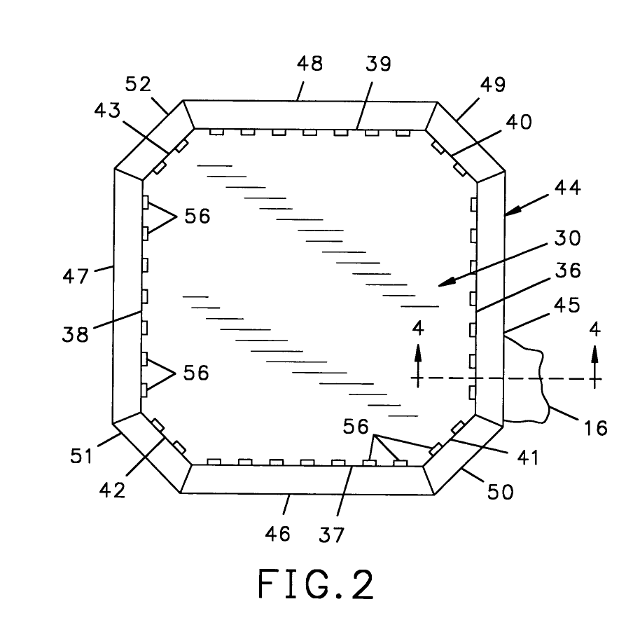

Referring to FIGS. 1 through 4, in accordance with the present invention, the acrylic panel or lens 30 is generally rectangular in shape with a forward surface 32 and rearward surface 34 and four generally equal outer sides 36, 37, 38, 39 such that the shape of the lens 30 is approximately square. In the embodiment depicted, the corners of the square of the lens 30 have been removed leaving four short angled sides 40, 41, 42, 43. The lens 30 is retained within a frame 44 having four generally equal in length long portions 45, 46, 47, 48 which fit opposite the long sides 40-43 of the lens 30, and four short sections 49, 50, 51, 52 which fit opposite the short sides 40-43 of the lens, such that the lens 30 fits snugly within the frame 44. Spaced along a surface of each of the frame members 45-52 so as to direct light into the ends of the lens 30, are a plurality of LEDs 56-56 that provide illumination to the interior of the enclosure 12.

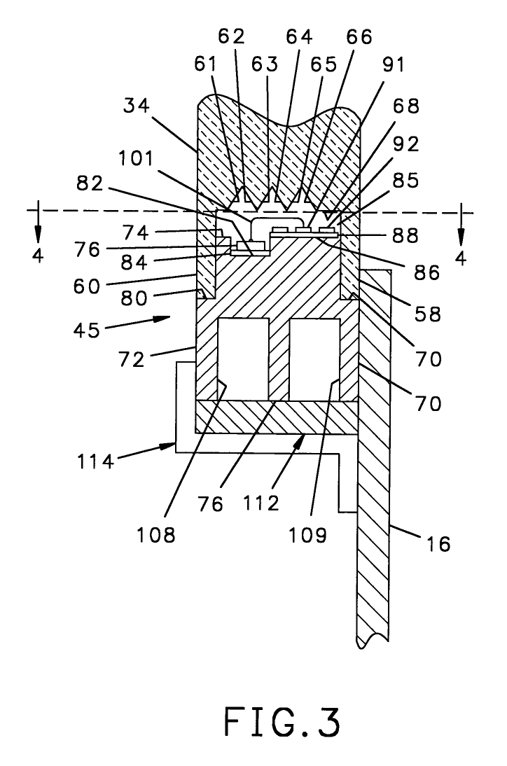

Referring to FIG. 3 which depicts the end of the side, in this case side 36, of the lens 30, and the portion of the frame 44 adjacent to it, in this case long portion 45. The configuration of side 36 of the lens 30 and of the adjacent frame portion 45, is representative of all the sides 36-43 of the lens 30 and the adjacent portions 45-52 of the frame 44. As can be seen, extending from the end 36 of lens 30 is a forward flange 58, the outer surface of which is co-planar with the forward surface 32. The flange 58 extends around the entire perimeter of the lens 30. Also extending from end 36 is a rearward flange 60, the outer surface of which is co-planar with the rearward surface 34 thereof. Between the forward and rearward flanges 58, 60, the lens 30 has a profile that may include a plurality of angled surfaces 61, 62, 63, 64, 65, 66 forming saw-tooth grooves and at least one planar portion 68, with the various surfaces 61-68 contoured to provide the most desirable disbursement through the lens 30 of light emitted from LEDs as further described below.

Frame member 45, which as previously stated is representative of all frame members 45-52, is made of a suitable heat-conductive material such as aluminum, so as to provide both a heat sink, and a rigid retainer for the lens 30. Each frame member 45 has a generally planar forward surface 70, and a generally planar rearward surface 72 parallel to the forward surface 70. The forward and rearward surfaces 70, 72 are spaced from each other by a distance approximately equal to the thickness of the lens 30. The frame member 45 further has an outer end 76 and an inner surface 74 directed toward the outer end 36 of the lens 30. The inner surface 74 has a forward shoulder 78 near the forward surface 70 adapted to receive the forward flange 58 of the lens 30 and adjacent the rearward surface 72 is a rearward shoulder 80 adapted to receive the rearward flange 60 of the lens 30.

As best shown in FIGS. 3 and 3A, the lengths 65, 67 of the flanges 58, 60 of the lens 30 are longer than the offsets 81, 83 between the shoulders 78, 80 and the central portion of the inner surface 74 of the frame member 45. Accordingly, a cavity 85 is formed bounded by the flanges 58, 60 and the central portion of the outer end 36 of the lens 30 and the central portion of the inner surface 74 of the frame member 45.

Extending between the forward shoulder 78 and rearward shoulder 80 of the inner surface 74 of the frame member is an elongate indentation 82, the surface of which is within the cavity 85 and spaced from the various surfaces 61-68 of the lens 30 when the parts are assembled together. A strip of dielectric material 84 is deposited into the indentation 82. Extending along the indentation 82 and the deposit o dielectric material 84 is an elongate planar surface 86 against which is deposited a strip of insulating material 88, and extending in parallel relationship above the insulating material 88 are a plurality of spaced electrically conductive buses 90, 91, 92.

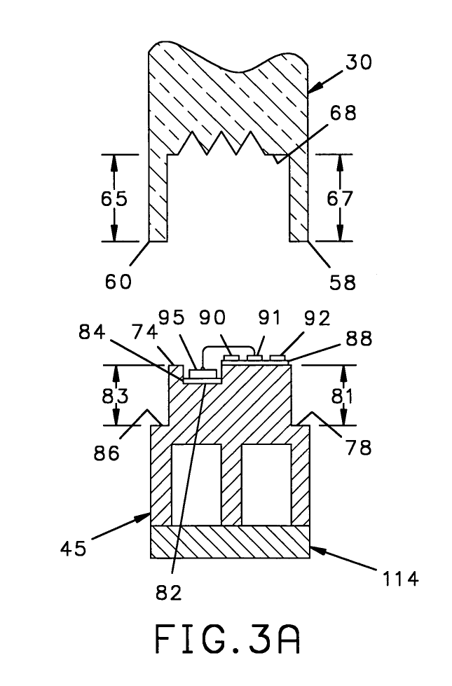

As best shown in FIG. 4, which again depicts frame member 45 as being representative of all the portions 45-53 of the frame 44 has, spaced at various positions along the length thereof, a plurality of deposits 94, 95, 96, 97, 98 on the dielectric material 84 so as to create on the surface of frame member 45 a plurality of spaced LEDs, 56-56. Connecting each of the deposits 94-98 is one end of suitable connecting wire 100, 101, 102, 103, 104 with the opposite end of the connecting wires 100-104 connected to one of the electrically conductive buses 90, 91, 92. The metal frame 44 consisting of the various portions 45-52 serves as the ground lead to all the LEDs 56-56 formed thereon.

As can be seen, the deposit of the dielectric material 84 against the electrically conductive frame member 45, upon which the deposits of the second material 94-98 are made along with the electrical connections 100-104 to the second deposits 94-98 forms a plurality of spaced LEDs 56 are formed along the length of the frame member 45. In accordance with the invention, therefore, a plurality of spaced LEDs are formed directly to the heat sink of the frame members 45.

The outer ends 76 of the frame member 45 have a configuration that is suitable for dispersing the heat energy absorbed into the frame 44 from the LEDs 56-56. spaced around the perimeter thereof. Accordingly, the outer end 76 of a frame member 45 may be configured into one or more channels 109, 110 against which an outer plate 112 may be fitted such that the channels 107,108 and the plate 112 form a conductive path through which a liquid or gaseous coolant may be directed to cool the frame 44.

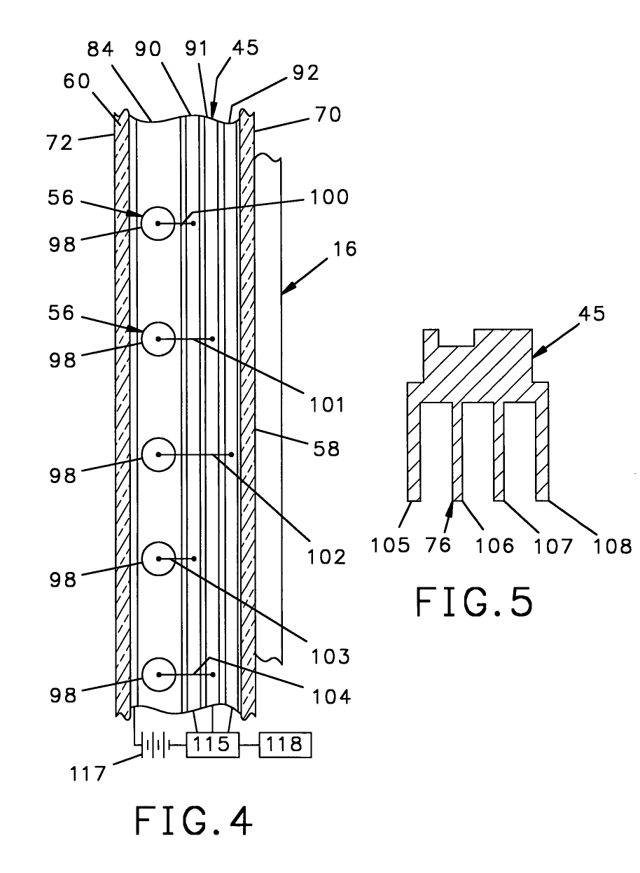

Referring to FIG. 5, the outer ends 76 of the frame members 45-52 may also be configured as a plurality of fins 105, 106,107 for disbursing heat directly in the air that circulates around the interior of the machine 10.

As also shown in FIG. 4, the frame 44 and any of its associated parts, such as the end plate 112, are retained in a bracket 114 for retaining the frame 44 and lens 30 against the inner surface of the front panel 16 of the vending machine 10. Accordingly, a plurality of LEDs 56-56 are positioned around the long sides 36-39 and short sides 40-43 of the lens 30 to provide illumination to the interior of the vending machine 10 such that the products therein being offered for sale are readily visible through the lens 30 to a potential customer.

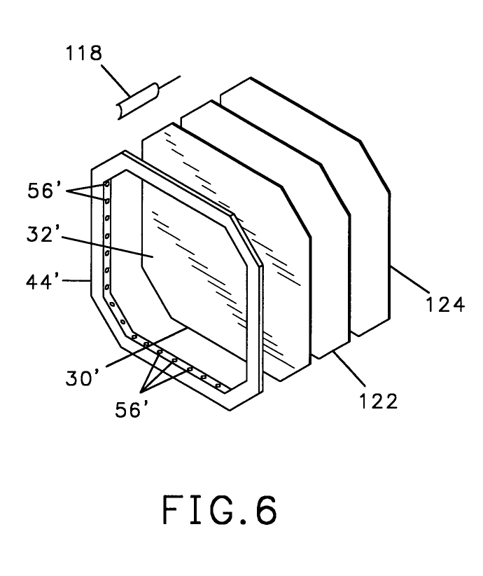

Referring to FIG. 6, in which an alternative embodiment a lens 30 and frame 44 in accordance with the present invention is employed to illuminate a panel of graphics material 114 fitted behind the lens 30. In this embodiment, it is desirable to provide a reflective panel 116 behind the panel of graphics material 114 to reflect any light that passes through the panel's graphics material 114 forwardly through the lens 30.

It should be appreciated that the deposits 94-98 that form the LEDs 56-56 may be chosen such that the lights emitted therefrom are of several different colors. Referring to FIG. 4 the various LEDs 94-98 may be illuminated in various combinations by separately energizing each of the various buses 90-92. By sequentially energizing the buses 90-92 and changing the various timing for which the buses are energized, the patterns and colors that are reflected through the lens 30 may be varied, creating a dancing light effect, to thereby enhance the attractiveness of the products being advertised in the vending machine 10. The illumination provided by the various LEDs 56-56 may also be altered in response to a proximity sensor 118, which detects the presence of a potential customer before the machine 10. In this embodiment, a microprocessor 115 is adapted to control the buses 90, 91, 92 and is programmed to direct power from a source 117 to energize the buses 90, 91, 92 in accordance with a second sequence when the proximity sensor 118 detects the presence of a potential patron.

Referring to FIG. 6, in another embodiment of the invention, a lens 30′ and frame 44′ having LEDs 56′-56′ formed on the frame 44′ may be used in combination with a graphics plate 120, behind which is positioned a reflective panel 122 and a touch grid 124. In this embodiment, the graphics on the graphics plate 122 may depict products to be sold in the machine which can be selected by a patron, not shown, by touching the forward surface 32′ of the lens 30′. The touch grid 124 will detect the contact of a finger against the adjacent portion of the forward surface 32′ of the lens 30′ and register the patron's selection of a desired product.

While the present invention has been described with respect to a number of embodiments, it will be appreciated that many modifications and variations may be made without departing from the true spirit and scope of the invention. It is therefore the intent of the appended claims to cover all such modifications and variations which fall within the true spirit and scope of invention.

What is claimed:

1. An illuminated lens comprising
a frame having an inner surface,
said inner surface made of an electrically conductive material,
a dielectric material deposited on said inner surface to form an LED,
a transparent lens having an outer edge, and
said transparent lens fitted against said frame with said outer edge adjacent said inner surface wherein light from said LED is directed into said outer edge.

2. The illuminated lens of claim 1 wherein said frame is made of a heat conductive material.

3. The illuminated lens of claim 2 wherein said frame is made of aluminum and said inner surface is a surface of said aluminum frame.

4. The illuminated lens of claim 3 wherein said frame has an outer end and said outer end includes means for dissipating heat generated by said LED.

5. The illuminated lens of claim 2 and further comprising
a bus extending along said frame wherein an electric potential is applied across said LED by connecting one contact of a source of electric power to said frame and a second contact of said source of electric power to said bus.

6. The illuminated lens of claim 2 and further comprising
a plurality of buses extending along said frames
said parallel buses being electrically insulated from each other and from said frame,
means for selectively connecting one contact of a source of electric power to one of said plurality of buses.

7. The illuminated lens of claim 6 wherein a second contact of said source of electric power is connected to said frame.

8. The illuminated lens of claim 1 and further comprising
an electrically conductive member extending parallel to and spaced from said inner surface, and
an at least partially insulating material between said electrically conductive member and said inner surface wherein an electric potential is applied across said inner surface and said electrically conductive member to provide electric energy to said LED.

9. The illuminated lens of claim 1 wherein said outer edge of said lens is contoured for enhancing the dispersion of light from said LED.
